(19) United States
(12) Patent Application Publication
(10) Pub. No.: US 2025/0174036 A1
(43) Pub. Date: May 29, 2025

(54) HAND POSE RECOGNITION METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Qichang SUN, Shenzhen (CN); Zhongyang ZHENG, Shenzhen (CN)

(21) Appl. No.: 19/034,528

(22) Filed: Jan. 22, 2025

Related U.S. Application Data
(63) Continuation of application No. PCT/CN2023/129598, filed on Nov. 3, 2023.

(30) Foreign Application Priority Data
Feb. 24, 2023 (CN) 202310215949.2

(51) Int. Cl. G06V 40/10

(52) U.S. Cl. CPC G06V 40/11

(57) ABSTRACT

A hand pose recognition method is performed by a computer device, including: acquiring a current frame of a multi-lens video of a target object; performing hand detection on a first view of the current frame to obtain a first lens detection result; performing hand estimation on a second view of the current frame to obtain a second lens estimation result; removing, from the hand detection boxes in the first view and the hand estimation boxes in the second view, redundant boxes corresponding to redundant hands, and then performing hand joint point recognition on remaining boxes to obtain two-dimensional joint points; converting the two-dimensional joint points into three-dimensional joint points in a three-dimensional hand coordinate system; and converting the three-dimensional joint points in the three-dimensional hand coordinate system into three-dimensional joint points of the current frame in a world coordinate system according to pose estimation parameters corresponding to the current frame.

### CROSS-REFERENCE TO RELATED APPLICATIONS

This application is a continuation application of PCT Patent Application No. PCT/CN2023/129598, entitled “HAND POSE RECOGNITION METHOD AND APPARATUS, DEVICE, STORAGE MEDIUM, AND PROGRAM PRODUCT” filed on Nov. 3, 2023, which claims priority to Chinese Patent Application No. 202310215949.2, entitled “HAND POSE RECOGNITION METHOD AND APPARATUS, DEVICE, STORAGE MEDIUM, AND PROGRAM PRODUCT” filed with the China National Intellectual Property Administration on Feb. 24, 2023, both of which are incorporated herein by reference in their entirety.

FIELD OF THE TECHNOLOGY

This application relates to the field of computer technologies, and in particular, to a hand pose recognition method and apparatus, a computer device, a storage medium, and a computer program product.

### BACKGROUND OF THE DISCLOSURE

With the development of computer technologies and artificial intelligence technologies, there are more and more application scenarios based on gesture interaction, for example, a somatosensory game and a somatosensory entertainment. In these application scenarios, by means of three-dimensional hand recognition, a user can naturally and intuitively interact with a device, and the device actively captures a hand pose of the user, and recognizes and processes the hand pose.

The hand pose recognition needs to collect multiple views and perform target detection on the multiple views to obtain hand detection boxes. In related technologies, to avoid acquiring the hand detection boxes by using a target detection algorithm as much as possible and reduce time consumption of image processing, the hand detection boxes are estimated. However, this estimation manner is not accurate enough, and especially when a wrist flips, estimated locations of hand joint points may be far away from actual hand joints. In addition, in the related technologies, all hands appearing in a picture are processed, and there is data redundancy, resulting in relatively high processing time.

### SUMMARY

According to embodiments provided by this application, a hand pose recognition method is performed by a computer device. The method includes:
acquiring a current frame of a multi-lens video, the multi-lens video being a video obtained by means of a multi-lens camera performing synchronous image collection on hands located in the same area, and the current frame including a plurality of views;
performing hand detection on a first view of the current frame to obtain a first lens detection result, the first lens detection result being configured for positioning hand detection boxes in the first view of the current frame;
performing hand estimation on a second view of the current frame to obtain a second lens estimation result, the second lens estimation result being configured for positioning hand estimation boxes in the second view of the current frame;
removing, from the hand detection boxes in the first view and the hand estimation boxes in the second view of the current frame, redundant boxes corresponding to redundant hands, and then performing hand joint point recognition on remaining boxes to obtain two-dimensional joint points corresponding to the current frame;
converting the two-dimensional joint points into three-dimensional joint points in a three-dimensional hand coordinate system; and
converting the three-dimensional joint points in the three-dimensional hand coordinate system into three-dimensional joint points of the current frame in a world coordinate system according to pose estimation parameters corresponding to the current frame, the three-dimensional joint points in the world coordinate system being configured for describing a three-dimensional hand pose of the hand in the current frame.

This application further provides a computer device. The computer device includes a memory and a processor. The memory has computer-readable instructions stored therein, and the processor, when executing the computer-readable instructions, cause the computer device to implement operations of the hand pose recognition method provided by the embodiments of this application.

This application further provides a non-transitory computer-readable storage medium. The computer-readable storage medium has computer-readable instructions stored therein. The computer-readable instructions, when executed by a processor of a computer device, cause the computer device to perform operations of the hand pose recognition method provided by the embodiments of this application are implemented.

Details of one or more embodiments of this application are provided in the accompanying drawings and descriptions below. Other features, objectives, and advantages of this application become clear from the specification, the drawings, and the claims.

### BRIEF DESCRIPTION OF THE DRAWINGS

To describe the technical solutions in the embodiments of this application more clearly, the following briefly describes the accompanying drawings required for describing the embodiments or conventional technologies. It is clear that the accompanying drawings in the following descriptions show merely some embodiments of this application, and a person of ordinary skill in the art may still derive other drawings from these disclosed accompanying drawings without creative efforts.

FIG. 1 is a diagram of an application environment of a hand pose recognition method according to an embodiment.

FIG. 2 is a schematic flowchart of a hand pose recognition method according to an embodiment.

FIG. 3 is a schematic diagram of performing hand detection on an image to obtain hand detection boxes according to an embodiment.

FIG. 4 is a schematic diagram of hand joint points according to an embodiment.

FIG. 5 is a schematic diagram of estimating hand estimation boxes of a current frame according to an embodiment.

FIG. 6 is a schematic diagram of a three-dimensional hand coordinate system according to an embodiment.

FIG. 7 is a schematic diagram of a two-dimensional finger coordinate system according to an embodiment.

FIG. 8 is a schematic diagram of hand joint points according to an embodiment.

FIG. 9 is a schematic flowchart of an operation of adjusting handness according to an embodiment.

FIG. 10 is a processing flowchart of a hand pose recognition method according to an embodiment.

FIG. 11 is a structural block diagram of a hand pose recognition apparatus according to an embodiment.

FIG. 12 is a diagram of an internal structure of a computer device according to an embodiment.

FIG. 13 a diagram of an internal structure of a computer device according to another embodiment.

### DESCRIPTION OF EMBODIMENTS

To make the objectives, technical solutions, and advantages of this application clearer, the following further describes this application in detail with reference to the accompanying drawings and the embodiments. The specific embodiments described herein are only used for explaining this application, and are not used for limiting this application.

The following describes some concepts involved in this application.
Keypoint/keypoints: mainly referring to a hand joint point/hand joint points.
Keypoint2D/keypoints2D: two-dimensional joint point/two-dimensional joint points, belonging to a two-dimensional image plane coordinate system and representing coordinates of a joint point/joint points of a hand in an image plane.
Keypoint3D/keypoints3D: a three-dimensional joint point/three-dimensional joint points, belonging to a three-dimensional world coordinate system and representing coordinates of a hand in a three-dimensional world.
Handness: classification information of a hand, whether it is a left hand or a right hand.
Lens: a lens of a camera.
View: an image shot by one lens of a multi-lens camera at a time. Different lenses of the camera have different shooting fields or angles, and the images taken are different.
Frame: a plurality of images shot by a plurality of lenses at a time. One frame includes a plurality of views.
Image detection model: image detection, as one of the tasks of computer vision, used for outputting a location and classification of an object in an image. Target detection is a task of image detection, which can output a location of a target object in an input image.

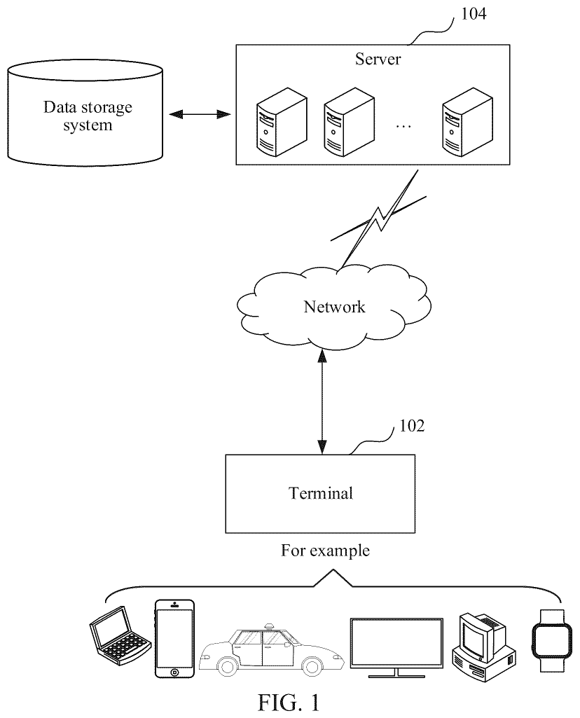

A hand pose recognition method provided by embodiments of this application may be applied to an application environment shown in FIG. 1. A terminal 102 communicates with a server 104 through a network. A data storage system may store data that needs to be processed by the server 104, such as cached detection boxes and corresponding handness. The data storage system may be integrated on the server 104, or may be placed on a cloud or another server.

In an embodiment, a multi-lens camera is connected to a terminal in a wired or wireless manner. The multi-lens camera may collect a multi-lens video. The terminal 102 acquires the multi-lens video collected by the multi-lens camera in real time and transmits the multi-lens video to the server 104. The server 104 performs hand detection on a first view of a current frame of the multi-lens video to obtain a first lens detection result, the first lens detection result being configured for positioning hand detection boxes in the first view of the current frame, and performs hand estimation on a second view of the current frame to obtain a second lens estimation result, the second lens estimation result being configured for positioning hand estimation boxes in the second view of the current frame. Next, the server 104 filters out or removes, from the hand detection boxes in the first view and the hand estimation boxes in the second view of the current frame, redundant boxes corresponding to redundant hands, and then performs hand joint point recognition on remaining boxes to obtain two-dimensional joint points corresponding to the current frame. Then, the two-dimensional joint points are converted into three-dimensional joint points in a three-dimensional hand coordinate system. The three-dimensional joint points in the three-dimensional hand coordinate system are converted into three-dimensional joint points of the current frame in a world coordinate system according to pose estimation parameters corresponding to the current frame. The three-dimensional joint points in the world coordinate system are configured for describing a three-dimensional hand pose of the hand in the current frame. In an embodiment, the server 104 may feed a recognized three-dimensional hand pose to the terminal 102, and the terminal 102 responds according to the three-dimensional hand pose. Certainly, alternatively, after the terminal 102 acquires the multi-lens video collected by the multi-lens camera in real time, the terminal 102 locally executes the foregoing operations to recognize the three-dimensional hand pose.

The terminal 102 may be, but is not limited to, various personal computers, notebook computers, smartphones, tablet computers, Internet of Things devices, and portable wearable devices. The Internet of Thing device may be a smart speaker, a smart television, a smart air conditioner, a smart in-vehicle device, or the like. The portable wearable device may be a smart watch, a smart band, a head-mounted device, or the like. The terminal 102 may alternatively be a virtual reality (VR) device. The server 104 may be implemented by using an independent server or a server cluster including a plurality of servers.

In related technologies, some procedures of hand pose recognition are as follows: First, target detection is separately performed on a plurality of views of a multi-lens camera by using a hand detection algorithm to output hand detection boxes and corresponding handness in each view. Then, after the hand detection boxes are cropped from each view, joint points in the hand detection boxes are recognized by a joint point recognition algorithm to output hand joint points in the hand detection boxes, i.e., to position the joint points. Finally, three-dimensional poses of hands are calculated according to the hand joint points in each view.

Disadvantages of the related technologies are at least as follows: Execution of the target detection algorithm is highly computational and time-consuming, and performing target detection on the plurality of views collected by all the lenses leads to long processing time and will affect the gesture recognition effect. Therefore, in some manners, to avoid acquiring the hand detection boxes by using the target detection algorithm as much as possible, the hand detection boxes are estimated. However, this estimation manner is not accurate when a wrist flips. Estimated locations of hand joint points may be far away from actual hand joints. In addition, even in this estimation manner, all the hands appearing in the picture will be processed, so there is data redundancy, which still leads to relatively high processing time.

According to the hand pose recognition method provided by the embodiment of this application, after a current frame of a multi-lens video is acquired, hand detection is performed on a first view of the current frame to obtain hand detection boxes in the first view. Hand detection is performed on only one view in the plurality of views each time, which can reduce the processing time. In addition, hand estimation is performed on a second view of the current frame to obtain hand estimation boxes in the second view. The hand detection boxes in the first view and the hand estimation boxes in the second view are jointly used as a basis for joint point recognition. In this way, both image information of the first lens and image information of the second lens are included, so that parallax information can be provided while the time consumption for detection is reduced, thereby improving the efficiency and accuracy of hand pose recognition. In addition, redundant boxes corresponding to redundant hands are filtered out from the hand detection boxes in the first view and the hand estimation boxes in the second view of the current frame, and hand joint point recognition is performed on remaining boxes to obtain two-dimensional joint points corresponding to the current frame, so that a data volume for joint point recognition can be reduced, thereby further reducing the processing time. By means of hand modeling, the two-dimensional joint points are converted into three-dimensional joint points in a three-dimensional hand coordinate system, and the three-dimensional joint points in the three-dimensional hand coordinate system are converted into three-dimensional joint points of the current frame in a world coordinate system according to pose estimation parameters corresponding to the current frame, thereby avoiding deviation of estimated hand joint points from actual hand joints in the related technologies, and improving the accuracy of hand pose recognition.

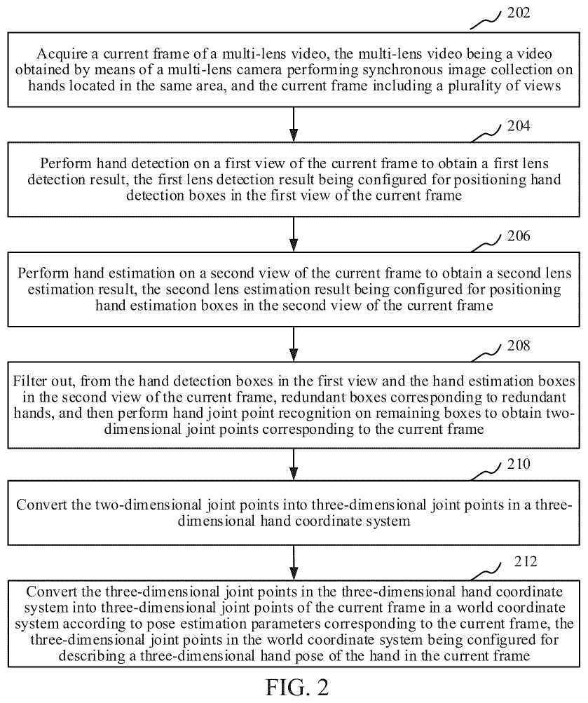

In an embodiment, as shown in FIG. 2, a hand pose recognition method is provided. An example in which the method is applied to the computer device (terminal or server) in FIG. 1 is used for description. The method includes the following operations:

Operation 202: Acquire a current frame of a multi-lens video, the multi-lens video being a video obtained by means of a multi-lens camera performing synchronous image collection on hands located in the same area, and the current frame including a plurality of views.

The multi-lens video described in the embodiment of this application is a video obtained by means of a multi-lens camera performing synchronous image collection on hands in the same area from different shooting angles. For example, in a VR gesture recognition scenario, a user places two hands or one hand in a preset area, and each lens in the multi-lens camera captures a video in the preset area from a different angle to obtain a multi-lens video. The multi-lens camera may be, for example, a dual-lens camera or a four-lens camera, which is not limited in the embodiment of this application.

Each frame of the multi-lens video is a set of video images collected respectively by each lens in the multi-lens camera at the same moment. The current frame may be understood as a set of video images respectively by each lens in the multi-lens camera at a current moment, i.e., the current frame includes a plurality of views. A previous frame may be understood as a set of video images respectively by each lens in the multi-lens camera at a previous moment.

For example, the current frame is two video images collected by a dual-lens camera at a t^{th} moment, and a previous frame is two video images collected by the dual-lens camera at a t-1^{th} moment. Alternatively, the current frame is a k^{th} frame which includes two views, and a previous frame is a k-1^{th} frame which also includes two views. The current moment and the previous moment here are dynamically changing, and accordingly, the current frame and the previous frame are also dynamically changing. The current frame may be understood as a currently processed frame, and after the current frame is processed, a next frame is obtained and becomes a new current frame.

Operation 204: Perform hand detection on a first view of the current frame to obtain a first lens detection result, the first lens detection result being configured for positioning hand detection boxes in the first view of the current frame.

In the embodiment of this application, the hand detection does not need to be performed on all images in the current frame. Instead, for each frame, the hand detection is performed on only one view. That is, the hand detection is performed on only one view in the plurality of views each time, which can reduce the processing time. The first view in the current frame is a view on which hand detection needs to be performed in the plurality of views included in the current frame, and the second view in the current frame is an image on which hand detection does not need to be performed in the plurality of views included in the current frame.

In a case that the multi-lens camera has two lenses, the number of images included in each frame is two. In this case, the number of images on which hand detection does not need to be performed, i.e., the number of the second views, is one. In a case that the multi-lens camera has more than two lenses, the number of images included in each frame is more than two. In this case, the number of images on which hand detection does not need to be performed, i.e., the number of the second views, is more than one.

In an embodiment, the computer device may perform hand detection on the first view of the current frame by using a pre-trained hand detection model to obtain a first lens detection result. The first lens detection result is configured for positioning hand detection boxes in the first view of the current frame. For example, the first lens detection result may include (m, n, w, h). (m, n) is a location of a top left corner (or a top right corner or a central point) of the hand detection box in the first view, w is a width of the hand detection box, and h is a height of the hand detection box. Based on the first lens detection result, the hand detection box may be positioned in the first view. When there are no hands in the first view, a corresponding first lens detection result indicates that there are no hand detection boxes in the first view, i.e., each value in (m, n, w, h) is null data. A hand detection process is a process of positioning an area in which a hand is located in an image, and this area may be a smallest rectangular box surrounding the hand in the image. FIG. 3 is a schematic diagram of performing hand detection on an image to obtain hand detection boxes according to an embodiment. In an embodiment, the first lens detection result may further include handness of the hand detection boxes, and the handness indicates whether the hand in the hand detection box is a left hand or a right hand.

In an embodiment, the hand detection model may be any model based on a neural network, which is not limited in the embodiment of this application. The hand detection model is obtained by training a large quantity of hand sample images, and a trained hand detection model has a capability of recognizing an area in which the hand is located from an image.

In an embodiment, the computer device may perform one-lens polling detection, i.e., the first view is an image determined from the current frame in a one-lens rolling manner. The one-lens rolling manner means that for each frame, hand detection is performed on only one view, and for an adjacent frame, hand detection is performed on an image from a different lens. For example, in a scenario where the multi-lens camera is a dual-lens camera, if an image for hand detection in a previous frame is collected by a 1^{st} lens in the multi-lens camera, then an image for hand detection in the current frame is collected by a 2^{nd} lens in the multi-lens camera, and an image for hand detection in a next frame is collected by the 1^{st} lens in the multi-lens camera. The detection is performed only for one lens each time, which can reduce the time consumption. Moreover, the detection for one lens each time is one-lens polling detection, so that information collected by every lens can be obtained macroscopically, thereby improving the accuracy of subsequent joint point recognition.

Operation 206: Perform hand estimation on a second view of the current frame to obtain a second lens estimation result, the second lens estimation result being configured for positioning hand estimation boxes in the second view of the current frame.

To not only avoid significant freezing experience caused by time consumption caused by performing hand detection on all images in one frame, but also obtain image information of multiple lenses to improve the accuracy of joint point recognition, in the embodiment of this application, hand detection is performed on the first view, and hand estimation is performed on the second view. In this way, parallax information formed by hand information provided by the second view and the hand detection boxes in the first view helps to improve the accuracy of hand pose recognition. The computer device may perform hand estimation on the second view of the current frame according to information of historical frames to obtain the second lens estimation result. The second lens estimation result is configured for positioning the hand estimation boxes in the second view of the current frame. The hand estimation boxes indicated by the second lens estimation result and the hand detection boxes indicated by the first lens detection result are combined into dual-lens boxes for subsequent hand joint point recognition.

After obtaining the first lens detection result and the second lens estimation result, the computer device may crop the hand detection boxes from the first view and the hand estimation boxes from the second view, perform subsequent hand joint point recognition according to the hand detection boxes, the hand estimation boxes, and corresponding handness to obtain two-dimensional joint points, and determine, based on the two-dimensional joint points, three-dimensional joint points of the current frame in a world coordinate system.

The two-dimensional joint points indicate locations of hand joint points in a two-dimensional image plane. A process of recognizing hand joint points is a process of predicting coordinates of hand joints in a two-dimensional image, and the two-dimensional image is, for example, the hand detection box cropped from the first view or the hand estimation box cropped from the second view. Exemplarily, FIG. 4 is a schematic diagram of 21 hand joint points according to an embodiment.

The three-dimensional joint points indicate locations of hand joint points in a three-dimensional coordinate system. The computer device may perform hand modeling to convert the two-dimensional joint points into the three-dimensional joint points in the three-dimensional hand coordinate system, and convert the three-dimensional joint points in the three-dimensional hand coordinate system into the three-dimensional joint points in the world coordinate system according to pose estimation parameters corresponding to the current frame and a conversion relationship between the three-dimensional hand coordinate system and the world coordinate system. The three-dimensional joint points in the world coordinate system can be configured for describing a three-dimensional hand pose of the hand in the current frame.

In an embodiment, the performing hand estimation on a second view of the current frame to obtain a second lens estimation result includes: acquiring three-dimensional joint points of each of previous two frames of the current frame in the world coordinate system; estimating the three-dimensional joint points of the current frame in the world coordinate system according to the three-dimensional joint points of each of the previous two frames in the world coordinate system, and reprojecting estimated three-dimensional joint points of the current frame in the world coordinate system to obtain estimated two-dimensional joint points of the current frame; and determining the hand estimation boxes in the second view of the current frame according to the estimated two-dimensional joint points of the current frame.

Specifically, after completing the hand pose recognition in one frame of the video, the computer device caches the recognition result of the frame, i.e., caches the three-dimensional joint points of hands in this frame of the video in the world coordinate system, which may be configured for subsequent estimation of hand estimation boxes. When processing the current frame, the computer device acquires the three-dimensional joint points of each of the previous two frames of the current frame in the world coordinate system. For example, the current frame is a k^{th} frame, and the previous two frames of the current frame is a k-1^{th} frame and a k-2^{th} frame. When processing the k^{th} frame, the computer device acquires the three-dimensional joint points of each of the k-1^{th} frame and the k-2^{th} frame in the world coordinate system, estimates the three-dimensional joint points of the current frame in the world coordinate system according to the three-dimensional joint points of each of the k-1^{th} frame and the k-2^{th} frame in the world coordinate system, reprojects estimated three-dimensional joint points to obtain estimated two-dimensional joint points of the current frame, and determines the hand estimation boxes in the second view of the current frame according to the estimated two-dimensional joint points of the current frame.

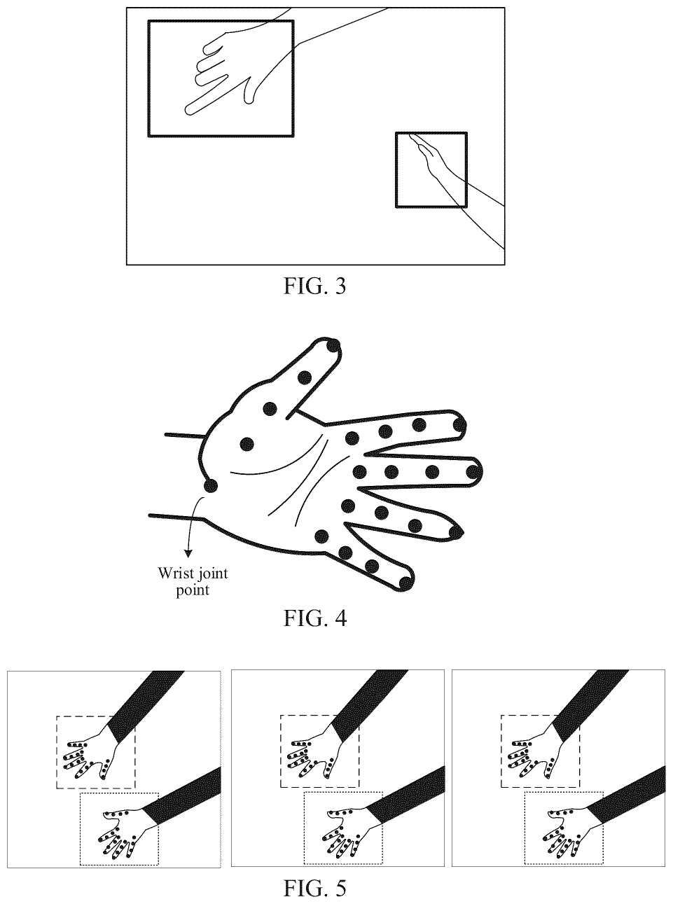

FIG. 5 is a schematic diagram of estimating, based on the three-dimensional hand joint points of the historical frames, the hand estimation boxes of the current frame according to an embodiment. Referring to FIG. 5, the left figure is a view on which hand detection is performed in a 128^{th} frame, the middle figure is a view on which hand detection is performed in a 129^{th} frame, and the right figure is a view on which hand estimation is performed in a 130^{th} frame. The boxes in the left figure and the middle figure are the hand detection boxes obtained by hand detection, and the boxes in the right figure are the hand estimation boxes obtained by hand estimation.

In an embodiment, the hand estimation boxes in the right figure may be estimated in the following manner.

In the 128^{th} frame, the three-dimensional joint points of the hands in the first view on which hand detection is performed in the world coordinate system are recorded as keypoints3D_2. In the 129^{th} frame, the three-dimensional joint points of the hands in the second view on which hand detection is performed in the world coordinate system are keypoints3D_1. In the 130^{th} frame, hand detection is performed on the first view, and hand estimation is performed on the second view. Then, the three-dimensional joint points of the hands in the second view in the 130^{th} frame in the world coordinate system are estimated:
keypoints3D_3=2*keypoints3D_2−keypoints3D_1, where keypoints3D_3 are the estimated three-dimensional joint points of the current frame in the world coordinate system.

Next, reprojection is performed to obtain the estimated two-dimensional joint points in the 130^{th} frame:
keypoints2D_3=reproject (keypoints3D_3), where reproject( ) is a reprojection function, and the two-dimensional joint points can represent locations of three-dimensional poses obtained by hand prediction on the second view in the 130^{th} frame in the two-dimensional image.

Next, the hand estimation boxes in the second view of the 130^{th} frame are determined:
box=bounding rectangle (keypoints2D_3).

In this way, hand location information can be obtained in the foregoing estimation manner without hand detection on the second view of the 130^{th} frame.

The computer device may perform hand estimation on the second view in the foregoing manner to obtain the hand estimation boxes used as hand information provided by the second view of the current frame, which is one of bases for subsequent hand joint point recognition.

In another implementation, because the image from which the hand detection boxes are derived in the previous frame and the image on which hand estimation is performed in the current frame are collected by the same lens, the computer device may also directly use the hand detection boxes of the previous frame as the hand information provided by the second view of the current frame, that is, the computer device caches the hand detection boxes obtained by hand detection in each frame, so that the hand detection boxes of the previous frame can be obtained when hand recognition is performed on the next frame.

In another implementation, in order to obtain the hand information of the second view in the current frame, the computer device may preferentially perform hand estimation on the second view of the current frame to obtain the hand estimation boxes. When it is determined that the hand estimation boxes in the second view are invalid after performing hand estimation on the second view of the current frame, the hand estimation boxes are discarded, and the cached detection boxes in the previous frame are used as detection information in the second view of the current frame. For example, the cached detection boxes may be cached hand detection boxes in the previous frame, or detection boxes positioned from the second view of the current frame according to coordinate information indicated by the hand detection boxes. In an embodiment, if no hand detection boxes are detected in the cached image on which hand detection is performed in the previous frame, that is, there are no cached hand detection boxes in the previous frame, the image information about the second view in the current frame cannot be obtained. The current frame needs to be discarded, and the next frame is acquired for processing.

In an embodiment, the computer device may further perform hand joint point recognition on the hand estimation boxes in the second view of the current frame to obtain a corresponding recognition result, the recognition result being two-dimensional joint points; calculate the three-dimensional joint points of the current frame in the world coordinate system according to the recognition result and the pose estimation parameters; and determine, when a difference between calculated three-dimensional joint points of the current frame in the world coordinate system and the estimated three-dimensional joint points of the current frame in the world coordinate system is greater than a preset threshold, that the hand estimation boxes in the second view are invalid.

The calculated three-dimensional joint points of the current frame in the world coordinate system represent three-dimensional poses obtained by performing hand joint point recognition on the second view in the current frame. The calculated three-dimensional joint points of the current frame in the world coordinate system are compared with the estimated three-dimensional joint points of the current frame in the world coordinate system to determine the difference therebetween, and whether the hand estimation boxes obtained by performing hand estimation on the second view of the current frame are reasonable may be determined according to the difference. If not, the hand estimation boxes in the second view of the current frame are discarded.

Operation 208: Filter out or removes, from the hand detection boxes in the first view and the hand estimation boxes in the second view of the current frame, redundant boxes corresponding to redundant hands, and then perform hand joint point recognition on remaining boxes to obtain two-dimensional joint points corresponding to the current frame.

If the hand estimation boxes in the second view of the current frame are valid, the computer device continues to perform, based on the hand detection boxes in the first view and the hand estimation boxes in the second view of the current frame, subsequent processing. In the embodiment of this application, considering a particular scenario, for example, a VR gesture interaction scenario, it is only necessary to focus on some hands of the user, for example, one or two hands of the user. Then, in order to reduce the data volume for hand joint point recognition and improve the efficiency of hand joint point recognition, the computer device may filter out the redundant boxes corresponding to the redundant hands and then perform hand joint point recognition on the remaining boxes, and there is no need to process all the hands in the image.

Specifically, the computer device may reserve a pair of hands or a hand closest to the image center, and the number of hands that need to be reserved may be set according to an actual requirement, which is not limited in the embodiment of this application. The other hands in the image are considered as the redundant hands, and corresponding boxes need to be filtered out and will not be processed. In addition, at least two boxes are reserved for each hand, and the at least two boxes are derived from different lenses, which can ensure that three-dimensional information of the hand can be restored. The at least two boxes may be two boxes.

In an embodiment, the first lens detection result includes the handness; and the filtering out, from the hand detection boxes in the first view and the hand estimation boxes in the second view of the current frame, redundant boxes corresponding to redundant hands includes: performing hand matching on the hand detection boxes in the first view and the hand estimation boxes in the second view of the current frame, and selecting, according to a matching result and the handness, a pair of boxes matched as the same left hand and a pair of boxes matched as the same right hand; reserving, if there are a plurality of different left hands, a pair of boxes of a left hand corresponding to a box closest to an image center; and reserving, if there are a plurality of different right hands, a pair of boxes of a right hand corresponding to a box closest to the image center.

Specifically, the computer device first performs hand matching on the plurality of views included in the current frame. For a plurality of boxes that are matched as the same hand, only a pair of boxes for different lenses and close to the image center need to be reserved. Then, based on the pair of boxes reserved, the hand close to the image center point is selected from the hands corresponding to these boxes, and the box corresponding to the selected hand is configured for subsequent hand joint point recognition to obtain the two-dimensional joint points corresponding to the current frame.

For example, a first view includes 3 hand detection boxes, namely 1A, 1B, and 1C, where 1A is the closest to the image center of the first view, the handness corresponding to 1A is a left hand, the handness corresponding to 1B is a right hand, the handness corresponding to 1C is a right hand, and 1C is closer to the image center than 1B.

A second view includes 2 hand estimation boxes, namely 2A and 2B, where 2A is closest to the image center of the second view, the handness corresponding to 2A is a left hand, the handness corresponding to 2B which is closest to the image center of the second view is a right hand.

A third view includes 3 hand estimation boxes, namely 3A, 3B, and 3C, where 3A is closer to the image center of the third view than 3C, the handness corresponding to 3A is a left hand, the handness corresponding to 3B is a right hand, and the handness corresponding to 3C is a left hand.

A fourth view includes 3 hand estimation boxes, namely 4A, 4B, and 4C, where 4A is closer to the image center of the fourth view than 4C, the handness corresponding to 4A is a left hand, the handness corresponding to 4B is a left hand, and the handness corresponding to 4C is a left hand.

After hand matching, 1A, 2A, and 4C are matched as the same left hand M, 3A and 4A are matched as the same left hand N, 1C and 2B are matched as the same right hand P, 1B and 3C are matched as the same right hand Q, 1B and 3B are matched as the same right hand, and 4B is a single left hand. Since information of at least two views is needed, 4B is filtered out first. Then, for the left hand M, the two boxes closest to the image center, namely 1A and 2A, are reserved; for the two left hands M and N, the redundant hand is filtered out, and only the left hand closest to the image center is reserved; and for the two right hands P and Q, the redundant hand is filtered out, and only the right hand closest to the image center is reserved. In this way, after the filtering, only one left hand and one right hand are reserved, and only two boxes from different lenses are reserved for each hand, which greatly reduces the data volume for subsequent hand joint point recognition. Certainly, in some scenarios in which only one right hand needs to be reserved, all left and right boxes may be filtered out.

Operation 210: Convert the two-dimensional joint points into three-dimensional joint points in a three-dimensional hand coordinate system.

As described above, the two-dimensional joint points indicate coordinates of hand joint points in the two-dimensional image plane, and may be recorded as (u, v). In order to obtain an accurate three-dimensional hand pose, the computer device needs to convert the two-dimensional joint points into three-dimensional joint points in a three-dimensional hand coordinate system so as to solve the three-dimensional coordinates of each hand joint point in the three-dimensional hand coordinate system, and then transform, based on the pose estimation parameters, the three-dimensional coordinates in the three-dimensional hand coordinate system into the world coordinate system.

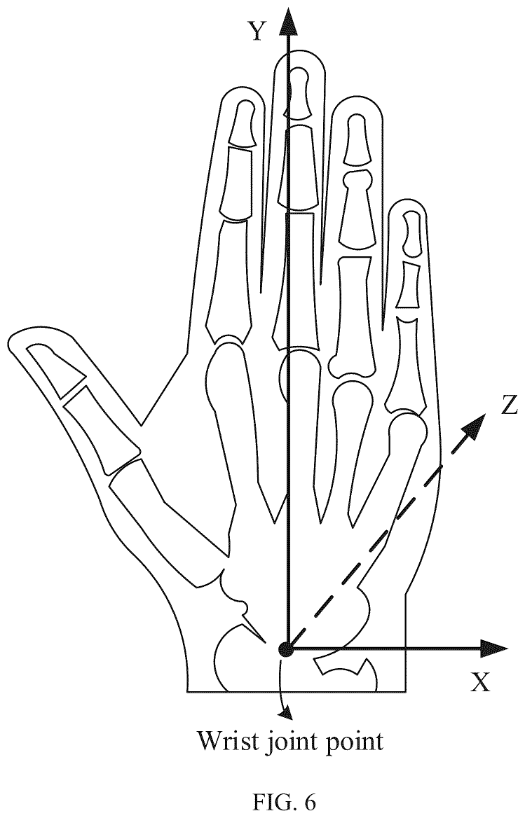

FIG. 6 is a schematic diagram of the three-dimensional hand coordinate system according to an embodiment. Referring to FIG. 6, the hand coordinate system is defined as shown in FIG. 6. When five fingers of a right hand are open, a plane in which the palm is located is defined as an XOY plane, a direction from the wrist joint point to the middle finger is defined as a Y axis direction, a direction perpendicular thereto on the little finger side is defined as an X axis direction, and a direction the palm faces is defined as a Z axis direction. Certainly, hand modeling may also be performed in another manner, which is not limited in the embodiment of this application.

In an embodiment, the two-dimensional joint points represent two-dimensional coordinates of joint points in an image plane coordinate system, and the three-dimensional hand joint points represent three-dimensional coordinates of the joint points in the three-dimensional hand coordinate system. The converting the two-dimensional joint points into three-dimensional joint points in a three-dimensional hand coordinate system includes:
taking two-dimensional coordinates of a target joint point in the image plane coordinate system as an origin of a two-dimensional finger coordinate system; determining two-dimensional coordinates of the adjacent joint point in the two-dimensional finger coordinate system according to an included angle of digital joints between the adjacent joint point of the target joint point and the target joint point in the two-dimensional finger coordinate system and a length of the digital joints; and converting the two-dimensional coordinates of the adjacent joint point in the two-dimensional finger coordinate system into the three-dimensional coordinates in the three-dimensional hand coordinate system according to a conversion relationship between the two-dimensional finger coordinate system and the three-dimensional hand coordinate system.

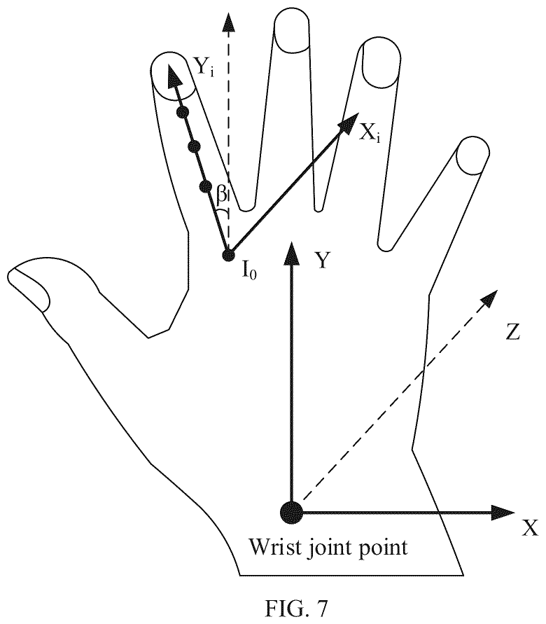

The target joint point may be any one of the hand joint points, and may be specified according to an actual requirement. In the embodiment of this application, the target joint point may be the hand joint point corresponding to the wrist, which is called a wrist joint point for short. After recognizing the two-dimensional coordinates (u, v) of each hand joint point in the image plane coordinate system by means of hand joint point recognition, the computer device may construct a two-dimensional finger coordinate system by using the wrist joint point as the origin of the two-dimensional finger coordinate system. FIG. 7 is a schematic diagram of a two-dimensional finger coordinate system according to an embodiment. Referring to FIG. 7, the two-dimensional finger coordinate system is defined as: the wrist joint point (I0 in the figure) is taken as the origin, the Z axis direction in the three-dimensional hand coordinate system is taken as an Xi axis direction of the two-dimensional finger coordinate system, a straightening direction of the index finger when the five fingers are open is taken as a Y_i axis direction of the two-dimensional finger coordinate system, and an included angle between the Yi axis direction of the two-dimensional finger coordinate system and the YOZ plane of the three-dimensional hand coordinate system is β, which may be determined according to an included angle between a straight line in which four digital joints of the index finger are located and the YOZ plane. Thereby, two coordinate axes of the two-dimensional finger coordinate system in the three-dimensional hand coordinate system are defined as:
Xi=(0, 0, 1), and Yi=(cos β, sin β, 0).

In this way, it may be obtained that the coordinates of any point (x, y) in the two-dimensional finger coordinate system in the three-dimensional hand coordinate system is xXi=yYi, i.e., (y cos β, y sin β, x), which is the conversion relationship between the two-dimensional finger coordinate system and the three-dimensional hand coordinate system.

The computer device may determine two-dimensional coordinates of the adjacent joint point in the two-dimensional finger coordinate system according to an included angle of digital joints between the adjacent joint point of the target joint point and the target joint point in the two-dimensional finger coordinate system and a length of the digital joints. The included angle and the length of the digital joints mentioned may be determined according to the two-dimensional coordinates (u, v) of the hand joint points in the image plane coordinate system.

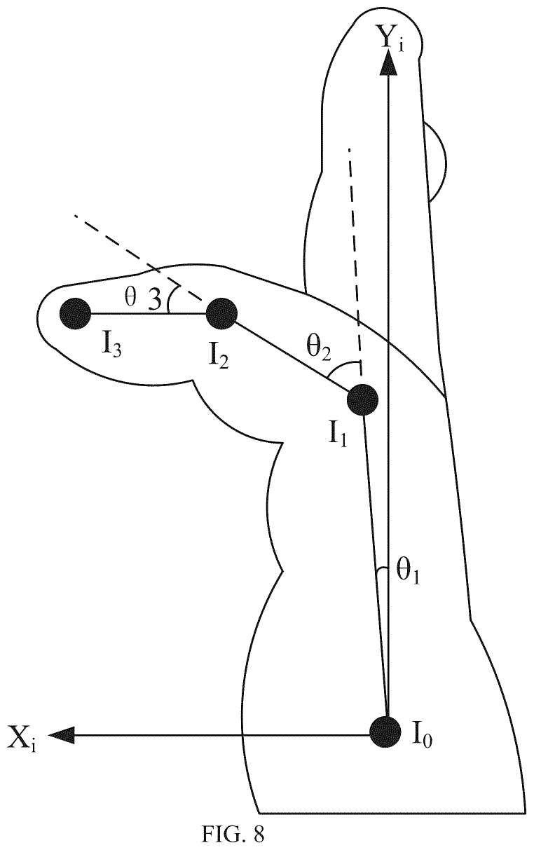

FIG. 8 is a schematic diagram of hand joint points according to an embodiment. For a connecting line between the hand joint point I1 and the wrist joint point I0 shown in FIG. 8, an included angle between the connecting line and the Yi axis of the two-dimensional finger coordinate system is θ1, and a length of the connecting line I0-I1 is Li1. Both the included angle and the length of the connecting line can be determined based on the two-dimensional coordinates of the wrist joint point I0 and the hand joint point I1 in the image plane coordinate system. Then, the coordinates I1 (x, y) of the hand joint point I1 in the two-dimensional finger coordinate system may be obtained according to the following formula:

$$I 1 ( x , y ) = I 0 + Li 1 ( sin θ1 , cos θ1 ) ,$$

where the coordinates of I0 in the two-dimensional finger coordinate system is (0, 0).

Similarly, for a connecting line I1-I2 between the hand joint point I2 and the hand joint point I1, an included angle between this connecting line and the connecting line I0-I1 is θ2, a length of the connecting line I1-I2 is Li2, and the coordinates I2(x, y) of the hand joint point I2 in the two-dimensional finger coordinate system may be obtained according to the following formula:

$$I 2 ( x , y ) = I 1 + Li 2 ( sin ( θ 1 + θ 2 ) , cos ( θ 1 + θ 2 ) ) .$$

Similarly, for a connecting line I2-I3 between the hand joint point I3 and the hand joint point I2, an included angle between this connecting line and the connecting line I1-I2 is θ3, a length of the connecting line I2-I3 is Li3, and the coordinates I3(x, y) of the hand joint point I3 in the two-dimensional finger coordinate system may be obtained according to the following formula:

$$I 3 ( x , y ) = I 2 + Li 3 ( sin ( θ 1 + θ 2 + θ 3 ) , cos ( θ 1 + θ 2 + θ 3 ) ) .$$

Next, according to the conversion relationship between the two-dimensional finger coordinate system and the three-dimensional hand coordinate system, xXi+yYi is substituted to obtain the three-dimensional coordinates of the hand joint points in the three-dimensional hand coordinate system.

Operation 212: Convert the three-dimensional joint points in the three-dimensional hand coordinate system into three-dimensional joint points of the current frame in a world coordinate system according to pose estimation parameters corresponding to the current frame, the three-dimensional joint points in the world coordinate system being configured for describing a three-dimensional hand pose of the hand in the current frame.

The pose estimation parameters include a camera parameter and joint rotation parameters. The camera parameter indicates a three-dimensional space in which the hand is located, and specifically, may be a distance matrix t from the hand joint point corresponding to the wrist to the camera, and the joint rotation parameters indicate a pose of the hand joint point, and specifically, are a rotation angle matrix R of the hand joint point corresponding to the wrist, and a rotation angle matrix angle of another joint point.

In an embodiment, the computer device may obtain the pose estimation parameters corresponding to the current frame in the following manner: acquiring the three-dimensional joint points of each of the previous two frames of the current frame in the world coordinate system; calculating pose estimation parameters of each of the previous two frames according to the three-dimensional joint points of each of the previous two frames in the world coordinate system; and performing interpolation on the pose estimation parameters of each of the previous two frames to obtain the pose estimation parameters corresponding to the current frame.

For example, when processing the k^{th} frame, the computer device acquires the three-dimensional joint points of each of the k-1^{th} frame and the k-2^{th} frame in the world coordinate system, and calculates the pose estimation parameters of each of the k-1^{th} frame and the k-2^{th} frame according to the three-dimensional joint points of each of the k-1^{th} frame and the k-2^{th} frame in the world coordinate system. The pose estimation parameters include the rotation angle matrix R of the hand joint point corresponding to the wrist, the distance matrix t from the hand joint point corresponding to the wrist to the camera, and the rotation angle matrix angle of another joint point. The computer device may perform interpolation according to the following formulae:
the rotation angle of the hand joint point corresponding to the wrist in the kth frame:

$$R ( k ) = R ( k - 1 ) * ( R ( k - 2 ) . inv ( ) * R ( k - 1 ) ) ,$$

where R(k-2). Inv( ) represents an inverse matrix of the matrix R(k−2);
the distance from the hand joint point corresponding to the wrist in the kth frame to the camera:

$$t ( k ) = 2 * t ( k - 1 ) - t ( k - 2 ) ;$$

and
the angle of another joint in the k^{th} frame: angle(k)=2*angle(k-1)−angle(k-2).

According to the above information obtained by interpolation, the three-dimensional joint points in the three-dimensional hand coordinate system can be converted into the three-dimensional joint points of the current frame in the world coordinate system, which can indicate the three-dimensional hand pose.

According to the hand pose recognition method and apparatus, the computer device, the storage medium, and the computer program product described above, after a current frame of a multi-lens video is acquired, hand detection is performed on a first view of the current frame to obtain hand detection boxes in the first view. Hand detection is performed on only one view in the plurality of views each time, which can reduce the processing time. In addition, hand estimation is performed on a second view of the current frame to obtain hand estimation boxes in the second view. The hand detection boxes in the first view and the hand estimation boxes in the second view are jointly used as a basis for joint point recognition. In this way, both image information of the first lens and image information of the second lens are included, so that parallax information can be provided while the time consumption for detection is reduced, thereby improving the efficiency and accuracy of hand pose recognition. In addition, redundant boxes corresponding to redundant hands are filtered out from the hand detection boxes in the first view and the hand estimation boxes in the second view of the current frame, and hand joint point recognition is performed on remaining boxes to obtain two-dimensional joint points corresponding to the current frame, so that a data volume for joint point recognition can be reduced, thereby further reducing the processing time. By means of hand modeling, the two-dimensional joint points are converted into three-dimensional joint points in a three-dimensional hand coordinate system, and the three-dimensional joint points in the three-dimensional hand coordinate system are converted into three-dimensional joint points of the current frame in a world coordinate system according to pose estimation parameters corresponding to the current frame, thereby avoiding deviation of estimated hand joint points from actual hand joints in the related technologies, and improving the accuracy of hand pose recognition.

As mentioned above, when the hand estimation boxes are invalid, the hand estimation boxes are discarded, and cached detection boxes are acquired instead. The cached detection boxes may be cached hand detection boxes in the previous frame, or detection boxes positioned from the second view of the current frame according to coordinate information indicated by the hand detection boxes.

Therefore, in an embodiment, the method further includes:
caching, when the first lens detection result indicates that there are hand detection boxes in the first view, the hand detection boxes in the first view of the current frame and corresponding handness.

In an embodiment, when the second lens estimation result indicates that the hand estimation boxes in the second view are invalid, the computer device may acquire cached detection boxes, the cached detection boxes being hand detection boxes in a second view obtained by performing hand detection in a previous frame of the current frame; and filter out, from the hand detection boxes in the first view and the cached detection boxes, redundant boxes corresponding to redundant hands, and then perform hand joint point recognition on the remaining boxes to obtain the two-dimensional joint point corresponding to the current frame.

In this embodiment, when the hand estimation boxes in the second view are invalid, the computer device may combine the hand detection boxes in the first view with the cached detection boxes into dual-lens boxes for subsequent hand joint point recognition. Here, before performing hand joint point recognition, it is required to filter out the redundant boxes corresponding to the redundant hands, and the manners are the same as the manners mentioned above, and will not be described in detail here.

In some cases, the hand detection boxes in which the hands are located may not be detected in the view for hand detection. In order to avoid undetected hand detection boxes and wrong handness during hand detection in an excessively complex or dull-light environment, for the view for hand detection in the current frame, not only hand detection, but also hand estimation is performed, i.e., both detection and estimation are performed.

That is, in an embodiment, the method may further include:

performing, when the first lens detection result indicates that there are no hand detection boxes in the first view, hand estimation on the first view of the current frame to obtain a first lens estimation result, the first lens estimation result being configured for positioning hand estimation boxes in the first view of the current frame; and filtering out, from the hand estimation boxes in the first view and the hand estimation boxes in the second view of the current frame, redundant boxes corresponding to redundant hands, and then performing hand joint point recognition on remaining boxes to obtain two-dimensional joint points corresponding to the current frame.

The manner of performing hand estimation on the first view is similar to the manner of performing hand estimation on the second view as mentioned above. That is, when processing the current frame, the computer device acquires the three-dimensional joint points of each of the previous two frames of the current frame in the world coordinate system. In an example where the current frame is the kth frame and the previous two frames of the current frame are the k-1^{th} frame and the k-2^{th} frame, when processing the kth frame, the computer device acquires the three-dimensional joint points of each of the k-1^{th} frame and the k-2^{th} frame in the world coordinate system, estimates the three-dimensional joint points of the current frame in the world coordinate system according to the three-dimensional joint points of each of the k-1^{th} frame and the k-2^{th} frame in the world coordinate system, reprojects estimated three-dimensional joint points to obtain estimated two-dimensional joint points in the current frame, and determines the hand estimation boxes in the first view of the current frame according to the estimated two-dimensional joint points in the current frame.

In this embodiment, when the first lens detection result indicates that there are no hand detection boxes in the first view, the computer device may combine the hand estimation boxes in the first view with the hand estimation boxes in the second view into dual-lens boxes for subsequent hand joint point recognition. That is, if there are hand detection boxes in the first view, the hand detection box in the first view and the hand estimation box in the second view are combined into a dual-lens box for subsequent processing; and if there are no hand detection boxes in the first view, the hand estimation boxes of the first view are configured for subsequent processing.

Similarly, before hand joint point recognition is performed, it is also required to filter out, from the hand estimation boxes in the first view and the hand estimation boxes in the second view of the current frame, redundant boxes corresponding to redundant hands. Specifically, if the hand estimation boxes in the second view of the current frame are valid, considering a particular scenario, for example, a VR gesture interaction scenario, it is only necessary to focus on some hands of the user, for example, one or two hands of the user. Then, in order to reduce the data volume for hand joint point recognition and improve the overall efficiency of hand recognition, the computer device may filter out the redundant boxes corresponding to the redundant hands and then perform hand joint point recognition on the remaining boxes, and there is no need to process all the hands in the image. The computer device may reserve a pair of hands or a hand closest to the image center, and the number of hands that need to be reserved may be set according to an actual requirement, which is not limited in the embodiment of this application. The other hands in the image are considered as the redundant hands, and corresponding boxes need to be filtered out and will not be processed. In addition, at least two boxes are reserved for each hand, and the at least two boxes are derived from different lenses, which can ensure that three-dimensional information of the hand can be restored. The at least two boxes may be two boxes.

In an embodiment, when the hand estimation boxes in the second view are invalid, the computer device may further combine the hand estimation boxes in the first view with the hand detection boxes in the second view obtained by performing hand detection in the previous frame of the current frame, i.e., the cached detection boxes, into dual-lens boxes for subsequent hand joint point recognition. Similarly, before hand joint point recognition is performed, it is also required to filter out, from the hand estimation boxes in the first view of the current frame and the cached detection boxes, redundant boxes corresponding to redundant hands.

As can be seen based on the foregoing description, in order to ensure the accuracy of joint point recognition, boxes derived from at least two lenses are needed. That is, the input of the hand joint point recognition model may be dual-lens boxes formed by the hand detection boxes and the hand estimation boxes, dual-lens boxes formed by the hand detection boxes and the cached detection boxes, dual-lens boxes formed by the hand estimation boxes and the hand estimation boxes, or dual-lens boxes formed by the hand estimation boxes and the cached detection boxes.

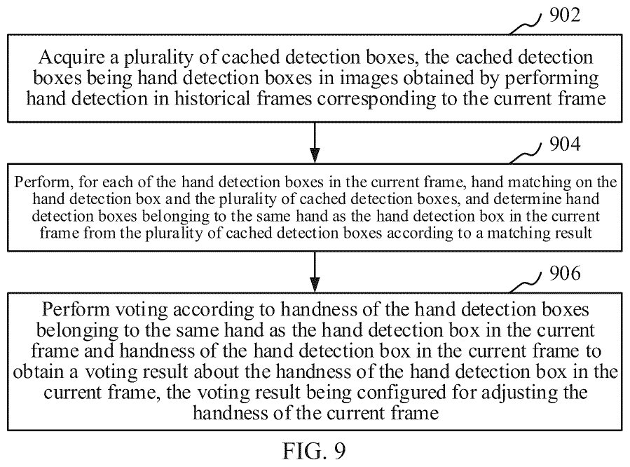

In an embodiment, as shown in FIG. 9, the first lens detection result includes the handness of the hand detection boxes, and the handness is configured for performing hand joint point recognition on the hand detection boxes. Before performing hand joint point recognition, the method further includes an operation of adjusting the handness, which specifically includes:

Operation 902: Acquire a plurality of cached detection boxes, the cached detection boxes being hand detection boxes in images obtained by performing hand detection in historical frames corresponding to the current frame.

As mentioned above, hand detection is performed on one of the views in each frame. When the detection result indicates that there are hand detection boxes in the view, the hand detection boxes in the first view and the corresponding handness are configured for subsequent hand joint point recognition. However, in a complex scenario or in a scenario with poor light, due to the natural symmetry of the left and right hands, the classification of the left and right hands is prone to errors, and hand classification is also a big challenge to the hand detection model itself. Therefore, when the detection result indicates that there are hand detection boxes in the view, the computer device may cache the hand detection boxes in the first view and the corresponding handness. The historical frames corresponding to the current frame may be L-1 frames previous to the current frame, and the L-1 frames and the current frame form L frames.

Operation 904: Perform, for each of the hand detection boxes in the current frame, hand matching on the hand detection box and the plurality of cached detection boxes, and determine, from the plurality of cached detection boxes, hand detection boxes belonging to the same hand as the hand detection box in the current frame according to a matching result.

In the view on which hand detection is performed in each frame, there may be a plurality of hands, so there are a plurality of hand detection boxes. Each hand detection box in the current frame is matched with the cached detection boxes in the historical frames, so that each hand detection box is matched to the same hand.

For example, the first view in the 1^{st} frame includes two hand detection boxes 1A and 1B, with handness of a left hand and a right hand sequentially, the second view in the 2^{nd} frame includes two hand detection boxes 2A and 2B, with handness of a left hand and a right hand sequentially, the first view in the 3^{rd} frame includes two hand detection boxes 3A and 3B, with handness of a left hand and a right hand sequentially, the second view in the 4^{th} frame includes two hand detection boxes 4A and 4B, with handness of a left hand and a left hand sequentially, and the first view in the 5^{th} frame includes two hand detection boxes 5A and 5B, with handness of a right hand and a right hand sequentially. Assuming that L is 5 and the current frame is the 5^{th} frame, after hand matching, 1A, 2A, 3A, 4A, and 5A are matched as the same hand H1, and 1B, 2B, 3B, 4B, and 5B are matched as the same hand H2.

Operation 906: Perform voting according to the handness of the hand detection boxes belonging to the same hand as the hand detection box in the current frame and the handness of the hand detection box in the current frame to obtain a voting result about the handness of the hand detection box in the current frame, the voting result being configured for adjusting the handness of the current frame.

In the above example, for H1, the handness of each frame is sequentially a left hand, a left hand, a left hand, a left hand, and a right hand. The classification information with a high number of votes is taken as the handness of the hand detection box 5A in the 5^{th} frame, which is a left hand, not the predicted right hand. For H2, the handness of each frame is sequentially a right hand, a right hand, a right hand, a left hand, and a right hand. The classification information with a high number of votes is taken as the handness of the hand detection box 5B in the 5^{th} frame, which is a right hand, indicating that the currently predicted right hand is correct.

In this way, when the handness is incorrect, reference may be made to historical classification information in a sliding window manner to adjust the handness of the hand detection box in the current frame as soon as possible, thereby ensuring a high-precision hand classification result.

In an embodiment, the method further includes:
correcting, if adjusted handness of the hand detection boxes in the current frame indicates that there are two left hands or two right hands in the current frame and according to the voting result, the adjusted handness to obtain corrected handness.

Specifically, in the embodiment in which the redundant hands are filtered out to limit the image to have only one left hand and one right hand, if the two hands in the image have the same handness, i.e., the voting results of the two hands both indicate a left hand or a right hand, one of the voting results is incorrect. In this case, the handness may be further corrected.

For example, the computer device may calculate a ratio of a number of left hands to a number of right hands in the voting result for each hand, i.e., LR_rate=left_count/right_count, where left_count represents the number of votes for the handness of a left hand, and right_count represents the number of votes for the handness of a right hand. If the voting results indicate that there are two left hands in the image (LR_rate is greater than 1 for both of the two hands), the handness of the hand detection box with a smaller LR_rate value is updated to a right hand. If the voting results indicate that there are two right hands in the image (LR_rate is less than 1 for both of the two hands), the handness of the hand detection box with a larger LR_rate value is updated to a left hand (indicating that the number of votes for a left hand is larger in a time window length L). In this way, the handness is corrected.

For example, the first view in the ^{st} frame includes two hand detection boxes 1A and 1B, with handness of a left hand and a right hand sequentially, the second view in the 2^{nd} frame includes two hand detection boxes 2A and 2B, with handness of a right hand and a right hand sequentially, the first view in the 3^{rd} frame includes two hand detection boxes 3A and 3B, with handness of a right hand and a right hand sequentially, the second view in the 4^{th} frame includes two hand detection boxes 4A and 4B, with handness of a left hand and a left hand sequentially, and the first view in the 5^{th} frame includes two hand detection boxes 5A and 5B, with handness of a right hand and a right hand sequentially. Assuming that L is 5 and the current frame is the 5^{th} frame, after hand matching, 1A, 2A, 3A, 4A, and 5A are matched as the same hand H1, and 1B, 2B, 3B, 4B, and 5B are matched as the same hand H2.

For H1, the handness of each frame is sequentially a left hand, a right hand, a right hand, a left hand, and a right hand. The classification information with a high number of votes is taken as the handness of the hand detection box 5A in the 5^{th} frame, which is a right hand. For H2, the handness of each frame is sequentially a right hand, a right hand, a right hand, a left hand, and a right hand. The classification information with a high number of votes is taken as the handness of the hand detection box 5B in the 5^{th} frame, which is a right hand.

In this case, the two hands are both right hands. Then, LR_rate corresponding to the hand detection box 5A is calculated, which is ⅔, and LR_rate corresponding to the hand detection box 5B is calculated, which is ⅕. This indicates that the hand in the hand detection box 5A is more likely to be a left hand, so the handness of the hand detection box 5A is corrected to a left hand.

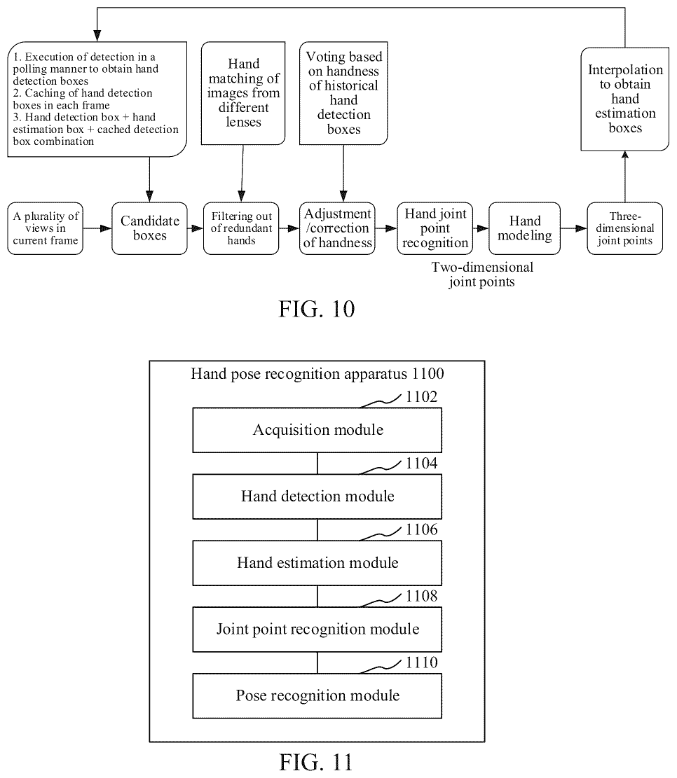

FIG. 10 is a flowchart of a hand pose recognition method according to an embodiment. Referring to FIG. 10, the input is the current frame, including a plurality of views. To obtain hand location information of the plurality of views in the current frame, the computer device preferentially performs hand detection on one of the plurality of views by one-lens polling detection to obtain a hand detection result, and at the same time, performs hand estimation on the other views by estimation to obtain a hand estimation result.

If the hand detection result indicates that there are hand detection boxes in the view and the hand estimation boxes in the other views are valid, then the hand detection boxes are combined with the hand estimation boxes into multi-lens boxes as candidate boxes.

If the hand detection result indicates that there are no hand detection boxes in the view and the hand estimation boxes in the other views are valid, then based on three-dimensional joint points in historical frames, hand estimation is performed on the view by estimation to obtain hand estimation boxes, and the hand estimation boxes obtained in the view are combined with the hand estimation boxes in the other views into multi-lens boxes as candidate boxes.

If the hand detection result indicates that there are hand detection boxes in the view and the hand estimation boxes in the other views are invalid, then cached detection boxes in the previous frame, i.e., cached detection boxes, are acquired, and the hand detection boxes are combined with the cached detection boxes into multi-lens boxes as candidate boxes.

If the hand detection result indicates that there are no hand detection boxes in the view and the hand estimation boxes in the other views are invalid, then hand estimation is performed on the view by estimation to obtain hand estimation boxes, cached detection boxes in the previous frame, i.e., cached detection boxes, are acquired, and the hand estimation boxes obtained in the view are combined with the cached detection boxes into multi-lens boxes as candidate boxes.

Further, to reduce the data volume for hand joint point recognition and improve the efficiency of hand joint point recognition, at most two hands or one hand is reserved in the image. For the foregoing candidate boxes, the computer device may perform hand matching on the plurality of views included in the current frame. For a plurality of boxes that are matched as the same hand, only a pair of boxes for different lenses and close to the image center need to be reserved. Then, based on the pair of boxes reserved, the hand close to the image center point is reserved among the hands corresponding to these boxes. The other hands in the image are considered as the redundant hands, and corresponding boxes need to be filtered out and will not be processed.

Further, to improve the precision of handness and the accuracy of subsequent hand joint point recognition, the computer device may further adjust the handness of the remaining candidate boxes after filtering. By caching the handness of historical detection boxes, based on hand matching results, voting for the handness is performed on the hand detection boxes in the current frame with reference to the handness of the historical detection boxes, the handness of the hand detection boxes in the current frame is confirmed or adjusted according to the voting results, and further correction is performed.

Then, the finally reserved hand boxes and the corresponding handness are inputted into a hand joint point recognition model which outputs two-dimensional coordinates of hand joint points in a two-dimensional image plane, and by means of hand modeling, the two-dimensional joint points are converted into three-dimensional joint points in a three-dimensional hand coordinate system. Finally, the three-dimensional joint points in the three-dimensional hand coordinate system are converted into three-dimensional joint points of the current frame in the world coordinate system according to pose estimation parameters corresponding to the current frame. The three-dimensional joint points in the world coordinate system are configured for describing a three-dimensional hand pose of the hand in the current frame. The hand pose recognition method provided by the embodiment of this application avoids and even corrects the problems in deep learning-based gesture models (a hand detection model and a hand joint point recognition model) without significantly increasing computing power required, so the hand pose recognition method can be applied to constructing a high-precision and smooth-running gesture interaction system. The operations in the flowcharts involved in the foregoing embodiments are displayed in sequence based on indication of arrows, but the operations are not necessarily performed sequentially according to a sequence indicated by the arrows. Unless otherwise explicitly specified herein, execution of the operations is not strictly limited in sequence, and the operations may be performed in other sequences. In addition, at least some operations in the flowcharts involved in the embodiments may include a plurality of operations or a plurality of stages, and these operations or stages are not necessarily performed at the same moment, and may be performed at different moments. The operations or stages are not necessarily performed in sequence, and may be performed in turns or alternately with other operations, or at least a part of operations or stages in the other operations. Based on the same inventive concept, the embodiment of this application further provides a hand pose recognition apparatus, configured to implement the foregoing hand pose recognition method. The implementation solution provided by the apparatus for resolving the problem is similar to the implementation solution recorded in the foregoing method. Therefore, for specific limitations on one or more following embodiments of the hand pose recognition apparatus, reference may be made to the limitations on the forgoing hand pose recognition method. Details are not described herein again.

In an embodiment, as shown in FIG. 11, a hand pose recognition apparatus 1100 is provided, including: an acquisition module 1102, a hand detection module 1104, a hand estimation module 1106, a joint point recognition module 1108, and a pose recognition module 1110.

The acquisition module 1102 is configured to acquire a current frame of a multi-lens video. The multi-lens video is a video obtained by means of a multi-lens camera performing synchronous image collection on hands located in the same area, and the current frame includes a plurality of views.

The hand detection module 1104 is configured to perform hand detection on a first view of the current frame to obtain a first lens detection result. The first lens detection result is configured for positioning hand detection boxes in the first view of the current frame.

The hand estimation module 1106 is configured to perform hand estimation on a second view of the current frame to obtain a second lens estimation result. The second lens estimation result is configured for positioning hand estimation boxes in the second view of the current frame.

The joint point recognition module 1108 is configured to filter out, from the hand detection boxes in the first view and the hand estimation boxes in the second view of the current frame, redundant boxes corresponding to redundant hands, and then perform hand joint point recognition on remaining boxes to obtain two-dimensional joint points corresponding to the current frame.

The pose recognition module 1110 is configured to convert the two-dimensional joint points into three-dimensional joint points in a three-dimensional hand coordinate system; and convert the three-dimensional joint points in the three-dimensional hand coordinate system into three-dimensional joint points of the current frame in a world coordinate system according to pose estimation parameters corresponding to the current frame. The three-dimensional joint points in the world coordinate system are configured for describing a three-dimensional hand pose of the hand in the current frame.

In an embodiment, the hand estimation module 1106 is further configured to perform, when the first lens detection result indicates that there are no hand detection boxes in the first view, hand estimation on the first view of the current frame to obtain a first lens estimation result. The first lens estimation result is configured for positioning hand estimation boxes in the first view of the current frame.

The joint point recognition module 1108 is further configured to filter out, from the hand estimation boxes in the first view and the hand estimation boxes in the second view of the current frame, redundant boxes corresponding to redundant hands, and then perform hand joint point recognition on remaining boxes to obtain two-dimensional joint points corresponding to the current frame.

In an embodiment, the hand pose recognition apparatus 1100 further includes:
a detection box caching module, configured to cache, when the first lens detection result indicates that there are hand detection boxes in the first view, the hand detection boxes in the first view of the current frame and corresponding handness.

In an embodiment, the hand pose recognition apparatus 1100 further includes:
a cached detection box acquisition module, configured to acquire, when the second lens estimation result indicates that the hand estimation boxes in the second view are invalid, cached detection boxes. The cached detection boxes are hand detection boxes in a second view obtained by performing hand detection in a previous frame of the current frame, or detection boxes positioned from the second view in the current frame according to the hand detection boxes.

The joint point recognition module 1108 is further configured to filter out, from the hand detection boxes in the first view and the cached detection boxes, redundant boxes corresponding to redundant hands, and then perform hand joint point recognition on the remaining boxes to obtain the two-dimensional joint point corresponding to the current frame.

In an embodiment, the hand estimation module 1106 is further configured to acquire three-dimensional joint points of each of previous two frames of the current frame in the world coordinate system; estimate the three-dimensional joint points of the current frame in the world coordinate system according to the three-dimensional joint points of each of the previous two frames in the world coordinate system, and reproject estimated three-dimensional joint points of the current frame in the world coordinate system to obtain estimated two-dimensional joint points of the current frame; and determine the hand estimation boxes in the second view of the current frame according to the estimated two-dimensional joint points of the current frame.

In an embodiment, the hand pose recognition apparatus 1100 further includes:
an estimation box evaluation module, configured to perform hand joint point recognition on the hand estimation boxes in the second view of the current frame; calculate the three-dimensional joint points of the current frame in the world coordinate system according to a detection result and the pose estimation parameters; and determine, when a difference between calculated three-dimensional joint points of the current frame in the world coordinate system and the estimated three-dimensional joint points of the current frame in the world coordinate system is greater than a preset threshold, that the hand estimation boxes in the second view are invalid.

In an embodiment, the first lens detection result includes the handness; and the joint point recognition module 1108 includes a redundant box filtering unit.

The redundant box filtering unit is configured to perform hand matching on the hand detection boxes in the first view and the hand estimation boxes in the second view of the current frame, and select, according to a matching result and the handness, a pair of boxes matched as the same left hand and a pair of boxes matched as the same right hand; reserve, if there are a plurality of different left hands, a pair of boxes of a left hand corresponding to a box closest to an image center; and reserve, if there are a plurality of different right hands, a pair of boxes of a right hand corresponding to a box closest to the image center.

In an embodiment, the first lens detection result includes the handness of the hand detection boxes, and the handness is configured for performing hand joint point recognition on the hand detection boxes. The hand pose recognition apparatus 1100 further includes:
a handness adjustment module, configured to acquire, before performing hand joint point recognition, a plurality of cached detection boxes, the cached detection boxes being hand detection boxes in images obtained by performing hand detection in historical frames corresponding to the current frame; perform, for each of the hand detection boxes in the current frame, hand matching on the hand detection box and the plurality of cached detection boxes, and determine, from the plurality of cached detection boxes, hand detection boxes belonging to the same hand as the hand detection box in the current frame according to a matching result; and perform voting according to the handness of the hand detection boxes belonging to the same hand as the hand detection box in the current frame and the handness of the hand detection box in the current frame to obtain a voting result about the handness of the hand detection box in the current frame, the voting result being configured for adjusting the handness of the current frame.

In an embodiment, the hand pose recognition apparatus 1100 further includes:
a handness correction module, configured to correct, if adjusted handness of the hand detection boxes in the current frame indicates that there are two left hands or two right hands in the current frame and according to the voting result, the adjusted handness to obtain corrected handness.

In an embodiment, the two-dimensional joint points represent two-dimensional coordinates of joint points in an image plane coordinate system; and the three-dimensional hand joint points represent three-dimensional coordinates of the joint points in the three-dimensional hand coordinate system.

The pose recognition module 1110 is further configured to take two-dimensional coordinates of a target joint point in the image plane coordinate system as an origin of a two-dimensional finger coordinate system; determine two-dimensional coordinates of the adjacent joint point in the two-dimensional finger coordinate system according to an included angle of digital joints between the adjacent joint point of the target joint point and the target joint point in the two-dimensional finger coordinate system and a length of the digital joints; and convert the two-dimensional coordinates of the adjacent joint point in the two-dimensional finger coordinate system into the three-dimensional coordinates in the three-dimensional hand coordinate system according to a conversion relationship between the two-dimensional finger coordinate system and the three-dimensional hand coordinate system.

In an embodiment, the pose recognition module 1110 is further configured to acquire the three-dimensional joint points of each of the previous two frames of the current frame in the world coordinate system; calculate pose estimation parameters of each of the previous two frames according to the three-dimensional joint points of each of the previous two frames in the world coordinate system; and perform interpolation on the pose estimation parameters of each of the previous two frames to obtain the pose estimation parameters corresponding to the current frame.

According to the forgoing hand pose recognition apparatus 1100, after a current frame of a multi-lens video is acquired, hand detection is performed on a first view of the current frame to obtain hand detection boxes in the first view. Hand detection is performed on only one view in the plurality of views each time, which can reduce the processing time. In addition, hand estimation is performed on a second view of the current frame to obtain hand estimation boxes in the second view. The hand detection boxes in the first view and the hand estimation boxes in the second view are jointly used as a basis for joint point recognition. In this way, both image information of the first lens and image information of the second lens are included, so that parallax information can be provided while the time consumption for detection is reduced, thereby improving the efficiency and accuracy of hand pose recognition. In addition, redundant boxes corresponding to redundant hands are filtered out from the hand detection boxes in the first view and the hand estimation boxes in the second view of the current frame, and hand joint point recognition is performed on remaining boxes to obtain two-dimensional joint points corresponding to the current frame, so that a data volume for joint point recognition can be reduced, thereby further reducing the processing time. By means of hand modeling, the two-dimensional joint points are converted into three-dimensional joint points in a three-dimensional hand coordinate system, and the three-dimensional joint points in the three-dimensional hand coordinate system are converted into three-dimensional joint points of the current frame in a world coordinate system according to pose estimation parameters corresponding to the current frame, thereby avoiding deviation of estimated hand joint points from actual hand joints in the related technologies, and improving the accuracy of hand pose recognition.

All or a part of the modules in the foregoing hand pose recognition apparatus 1100 may be implemented by using software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

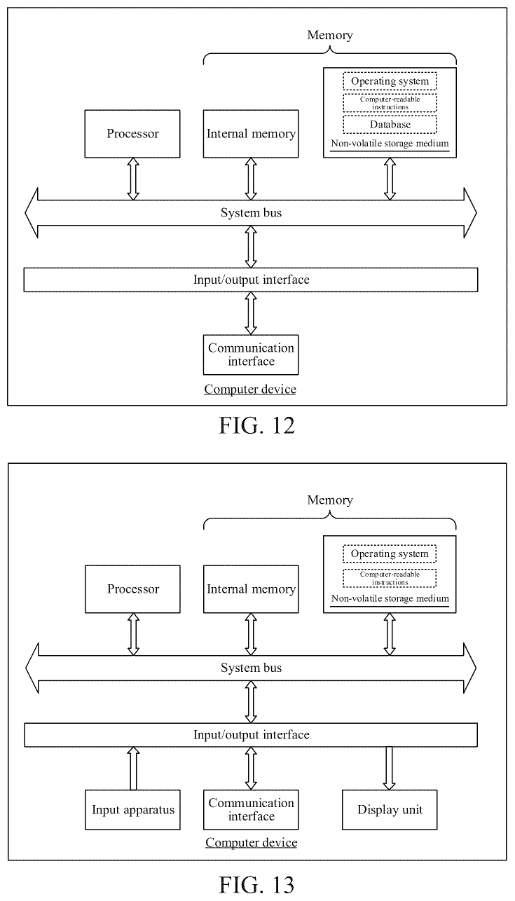

In an embodiment, a computer device is provided. The computer device may be a server. An internal structure thereof may be as shown in FIG. 12. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computation and control ability. The memory of the computer device includes a non-volatile storage medium and an internal memory. The non-volatile storage medium has an operating system, computer-readable instructions, and a database stored therein. The internal memory provides an operating environment for the operating system and the computer-readable instructions in the non-volatile storage medium. The database of the computer device is configured to store historical frame related data. The input/output interface of the computer device is configured to exchange information between the processor and external devices. The communication interface of the computer device is configured to connect and communicate with an external terminal through a network. When the computer-readable instructions are executed by the processor, a hand pose recognition method is implemented.

In an embodiment, a computer device is provided. The computer device may be a terminal. An internal structure thereof may be as shown in FIG. 13. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computation and control ability. The memory of the computer device includes a non-volatile storage medium and an internal memory. The non-volatile storage medium has an operating system and computer-readable instructions stored therein. The internal memory provides an operating environment for the operating system and the computer-readable instructions in the non-volatile storage medium. The input/output interface of the computer device is configured to exchange information between the processor and external devices. The communication interface of the computer device is configured to communicate with an external terminal in a wired or wireless manner. The wireless manner may be implemented through WiFi, a mobile cellular network, near field communication (NFC), or another technology. When the computer-readable instructions are executed by the processor, a hand pose recognition method is implemented. The display unit of the computer device is configured to form a visible picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

A person skilled in the art may understand that, the structure shown in FIG. 12 and FIG. 13 is merely a block diagram of a partial structure related to a solution in this application, and does not constitute a limitation to the computer device to which the solution in this application is applied. Specifically, the computer device may include more or fewer components than those shown in the figure, or have some components combined, or have a different component deployment.

In an embodiment, a computer device is further provided, including a memory and a processor. The memory stores computer-readable instructions. When the processor executes the computer-readable instructions, the operations in the hand pose recognition method provided by any embodiment of this application are implemented.

In an embodiment, a non-transitory computer-readable storage medium is provided, having computer-readable instructions stored therein. When the computer-readable instructions are executed by a processor, the operations in the hand pose recognition method provided by any embodiment of this application are implemented.

In an embodiment, a computer program product is provided, including computer-readable instructions. When the computer-readable instructions are executed by a processor, the operations in the hand pose recognition method provided by any embodiment of this application are implemented.

User information (including, but not limited to, user equipment information and user personal information) and data (including, but not limited to, data for analysis, stored data, and displayed data) involved in this application are all information and data authorized by users or fully authorized by all parties, and collection, use, and processing of relevant data need to comply with relevant laws, regulations, and standards of relevant countries and regions.

A person of ordinary skill in the art may understand that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database, or another medium used in the embodiments provided in this application can include at least one of a non-volatile or volatile memory. The non-volatile memory can include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), and a graphene memory. The volatile memory may be a random access memory (RAM), an external cache, or the like. As an illustration rather than a limitation, the RAM is available in various forms, such as a static random access memory (SRAM) or a dynamic random access memory (DRAM). The database involved in the embodiments provided in this application may include at least one of a relational database or a non-relational database. The non-relational database may include a blockchain-based distributed database, but is not limited thereto. The processor involved in the embodiments provided in this application may be a general-purpose processor, a central processing unit, a graphics processing unit, a digital signal processor, a programmable logic device, a quantum computing-based data processing logic device, or the like, but is not limited thereto.

Technical features of the foregoing embodiments may be combined in different manners to form other embodiments. To make description concise, not all possible combinations of the technical features in the foregoing embodiments are described. However, the combinations of these technical features are to be considered as falling within the scope recorded by this specification provided that no conflict exists.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application is to be subject to the appended claims.

What is claimed is:

1. A hand pose recognition method performed by a computer device, the method comprising:
acquiring a current frame of a multi-lens video of a target object, and the current frame comprising a plurality of views;
performing hand detection on a first view of the current frame to obtain a first lens detection result, the first lens detection result including hand detection boxes in the first view of the current frame;
performing hand estimation on a second view of the current frame to obtain a second lens estimation result, the second lens estimation result including hand estimation boxes in the second view of the current frame;
removing, from the hand detection boxes in the first view and the hand estimation boxes in the second view of the current frame, redundant boxes corresponding to redundant hands to obtain remaining hand detection boxes;
performing hand joint point recognition on the remaining hand detection boxes to obtain two-dimensional joint points corresponding to the current frame;
converting the two-dimensional joint points into three-dimensional joint points in a three-dimensional hand coordinate system; and
converting the three-dimensional joint points in the three-dimensional hand coordinate system into three-dimensional joint points of the current frame in a world coordinate system according to pose estimation parameters corresponding to the current frame.

2. The method according to claim 1, further comprising:
performing, when the first lens detection result indicates that there are no hand detection boxes in the first view, hand estimation on the first view of the current frame to obtain a first lens estimation result, the first lens estimation result being configured for positioning hand estimation boxes in the first view of the current frame;
removing, from the hand estimation boxes in the first view and the hand estimation boxes in the second view of the current frame, redundant boxes corresponding to redundant hands to obtain remaining hand estimation boxes; and
performing hand joint point recognition on the remaining hand estimation boxes to obtain the two-dimensional joint points corresponding to the current frame.

3. The method according to claim 1, wherein the performing hand estimation on a second view of the current frame to obtain a second lens estimation result comprises:
acquiring three-dimensional joint points of each of previous two frames of the current frame in the world coordinate system;
estimating the three-dimensional joint points of the current frame in the world coordinate system according to the three-dimensional joint points of each of the previous two frames in the world coordinate system, and reprojecting estimated three-dimensional joint points of the current frame in the world coordinate system to obtain estimated two-dimensional joint points of the current frame; and
determining the hand estimation boxes in the second view of the current frame according to the estimated two-dimensional joint points of the current frame.

4. The method according to claim 1, wherein the removing, from the hand detection boxes in the first view and the hand estimation boxes in the second view of the current frame, redundant boxes corresponding to redundant hands to obtain remaining hand detection boxes comprises:
performing hand matching on the hand detection boxes in the first view and the hand estimation boxes in the second view of the current frame, and selecting, according to a matching result, a pair of boxes matched as the same left hand and a pair of boxes matched as the same right hand;
reserving, if there are a plurality of different left hands, a pair of boxes of a left hand corresponding to a box closest to an image center; and
reserving, if there are a plurality of different right hands, a pair of boxes of a right hand corresponding to a box closest to the image center.

5. The method according to claim 1, wherein before performing hand joint point recognition, the method further comprises:
acquiring a plurality of cached detection boxes, the cached detection boxes being hand detection boxes in images obtained by performing hand detection in historical frames corresponding to the current frame;
performing, for each of the hand detection boxes in the current frame, hand matching on the hand detection box and the plurality of cached detection boxes, and determining, from the plurality of cached detection boxes, hand detection boxes belonging to the same hand as the hand detection box in the current frame according to a matching result; and
performing voting according to the hand detection boxes belonging to the same hand as the hand detection box in the current frame and the hand detection box in the current frame to obtain a voting result about the hand detection box in the current frame.

6. The method according to claim 1, wherein the two-dimensional joint points represent two-dimensional coordinates of joint points in an image plane coordinate system; the three-dimensional hand joint points represent three-dimensional coordinates of the joint points in the three-dimensional hand coordinate system; and
the converting the two-dimensional joint points into three-dimensional joint points in a three-dimensional hand coordinate system comprises:
taking two-dimensional coordinates of a target joint point in the image plane coordinate system as an origin of a two-dimensional finger coordinate system;
determining an adjacent joint point of the target joint point;
determining two-dimensional coordinates of the adjacent joint point in the two-dimensional finger coordinate system according to an included angle of digital joints between the adjacent joint point and the target joint point in the two-dimensional finger coordinate system and a length of the digital joints; and
converting the two-dimensional coordinates of the adjacent joint point in the two-dimensional finger coordinate system into the three-dimensional coordinates in the three-dimensional hand coordinate system according to a conversion relationship between the two-dimensional finger coordinate system and the three-dimensional hand coordinate system.

7. The method according to claim 1, further comprising:
acquiring the three-dimensional joint points of each of the previous two frames of the current frame in the world coordinate system;
calculating pose estimation parameters of each of the previous two frames according to the three-dimensional joint points of each of the previous two frames in the world coordinate system; and
performing interpolation on the pose estimation parameters of each of the previous two frames to obtain the pose estimation parameters corresponding to the current frame.

8. The method according to claim 1, wherein the multi-lens video is a video obtained by means of a multi-lens camera performing synchronous image collection on hands of the target object.

9. A computer device, comprising a memory and a processor, the memory having computer-readable instructions stored therein, and the processor, when executing the computer-readable instructions, causing the computer device to implement a hand pose recognition method including:
acquiring a current frame of a multi-lens video of a target object, and the current frame comprising a plurality of views;
performing hand detection on a first view of the current frame to obtain a first lens detection result, the first lens detection result including hand detection boxes in the first view of the current frame;
performing hand estimation on a second view of the current frame to obtain a second lens estimation result, the second lens estimation result including hand estimation boxes in the second view of the current frame;
removing, from the hand detection boxes in the first view and the hand estimation boxes in the second view of the current frame, redundant boxes corresponding to redundant hands to obtain remaining hand detection boxes;
performing hand joint point recognition on the remaining hand detection boxes to obtain two-dimensional joint points corresponding to the current frame;
converting the two-dimensional joint points into three-dimensional joint points in a three-dimensional hand coordinate system; and
converting the three-dimensional joint points in the three-dimensional hand coordinate system into three-dimensional joint points of the current frame in a world coordinate system according to pose estimation parameters corresponding to the current frame.

10. The computer device according to claim 9, wherein the method further comprises:
performing, when the first lens detection result indicates that there are no hand detection boxes in the first view, hand estimation on the first view of the current frame to obtain a first lens estimation result, the first lens estimation result being configured for positioning hand estimation boxes in the first view of the current frame;
removing, from the hand estimation boxes in the first view and the hand estimation boxes in the second view of the current frame, redundant boxes corresponding to redundant hands to obtain remaining hand estimation boxes; and
performing hand joint point recognition on the remaining hand estimation boxes to obtain the two-dimensional joint points corresponding to the current frame.

11. The computer device according to claim 9, wherein the performing hand estimation on a second view of the current frame to obtain a second lens estimation result comprises:
acquiring three-dimensional joint points of each of previous two frames of the current frame in the world coordinate system;
estimating the three-dimensional joint points of the current frame in the world coordinate system according to the three-dimensional joint points of each of the previous two frames in the world coordinate system, and reprojecting estimated three-dimensional joint points of the current frame in the world coordinate system to obtain estimated two-dimensional joint points of the current frame; and
determining the hand estimation boxes in the second view of the current frame according to the estimated two-dimensional joint points of the current frame.

12. The computer device according to claim 9, wherein the removing, from the hand detection boxes in the first view and the hand estimation boxes in the second view of the current frame, redundant boxes corresponding to redundant hands to obtain remaining hand detection boxes comprises:
performing hand matching on the hand detection boxes in the first view and the hand estimation boxes in the second view of the current frame, and selecting, according to a matching result, a pair of boxes matched as the same left hand and a pair of boxes matched as the same right hand;
reserving, if there are a plurality of different left hands, a pair of boxes of a left hand corresponding to a box closest to an image center; and
reserving, if there are a plurality of different right hands, a pair of boxes of a right hand corresponding to a box closest to the image center.

13. The computer device according to claim 9, wherein before performing hand joint point recognition, the method further comprises:
acquiring a plurality of cached detection boxes, the cached detection boxes being hand detection boxes in images obtained by performing hand detection in historical frames corresponding to the current frame;
performing, for each of the hand detection boxes in the current frame, hand matching on the hand detection box and the plurality of cached detection boxes, and determining, from the plurality of cached detection boxes, hand detection boxes belonging to the same hand as the hand detection box in the current frame according to a matching result; and
performing voting according to the hand detection boxes belonging to the same hand as the hand detection box in the current frame and the hand detection box in the current frame to obtain a voting result about the hand detection box in the current frame.

14. The computer device according to claim 9, wherein the two-dimensional joint points represent two-dimensional coordinates of joint points in an image plane coordinate system;
the three-dimensional hand joint points represent three-dimensional coordinates of the joint points in the three-dimensional hand coordinate system; and
the converting the two-dimensional joint points into three-dimensional joint points in a three-dimensional hand coordinate system comprises:
taking two-dimensional coordinates of a target joint point in the image plane coordinate system as an origin of a two-dimensional finger coordinate system;
determining an adjacent joint point of the target joint point;
determining two-dimensional coordinates of the adjacent joint point in the two-dimensional finger coordinate system according to an included angle of digital joints between the adjacent joint point and the target joint point in the two-dimensional finger coordinate system and a length of the digital joints; and
converting the two-dimensional coordinates of the adjacent joint point in the two-dimensional finger coordinate system into the three-dimensional coordinates in the three-dimensional hand coordinate system according to a conversion relationship between the two-dimensional finger coordinate system and the three-dimensional hand coordinate system.

15. The computer device according to claim 9, wherein the method further comprises:
acquiring the three-dimensional joint points of each of the previous two frames of the current frame in the world coordinate system;
calculating pose estimation parameters of each of the previous two frames according to the three-dimensional joint points of each of the previous two frames in the world coordinate system; and
performing interpolation on the pose estimation parameters of each of the previous two frames to obtain the pose estimation parameters corresponding to the current frame.

16. The computer device according to claim 9, wherein the multi-lens video is a video obtained by means of a multi-lens camera performing synchronous image collection on hands of the target object.

17. A non-transitory computer-readable storage medium, having computer-readable instructions stored therein, wherein the computer-readable instructions, when executed by a processor of a computer device, cause the computer device to perform a hand pose recognition method including:
acquiring a current frame of a multi-lens video of a target object, and the current frame comprising a plurality of views;
performing hand detection on a first view of the current frame to obtain a first lens detection result, the first lens detection result including hand detection boxes in the first view of the current frame;
performing hand estimation on a second view of the current frame to obtain a second lens estimation result, the second lens estimation result including hand estimation boxes in the second view of the current frame;
removing, from the hand detection boxes in the first view and the hand estimation boxes in the second view of the current frame, redundant boxes corresponding to redundant hands to obtain remaining hand detection boxes;
performing hand joint point recognition on the remaining hand detection boxes to obtain two-dimensional joint points corresponding to the current frame;
converting the two-dimensional joint points into three-dimensional joint points in a three-dimensional hand coordinate system; and
converting the three-dimensional joint points in the three-dimensional hand coordinate system into three-dimensional joint points of the current frame in a world coordinate system according to pose estimation parameters corresponding to the current frame.

18. The non-transitory computer-readable storage medium according to claim 17, wherein the method further comprises:
performing, when the first lens detection result indicates that there are no hand detection boxes in the first view, hand estimation on the first view of the current frame to obtain a first lens estimation result, the first lens estimation result being configured for positioning hand estimation boxes in the first view of the current frame;
removing, from the hand estimation boxes in the first view and the hand estimation boxes in the second view of the current frame, redundant boxes corresponding to redundant hands to obtain remaining hand estimation boxes; and
performing hand joint point recognition on the remaining hand estimation boxes to obtain the two-dimensional joint points corresponding to the current frame.

19. The non-transitory computer-readable storage medium according to claim 17, wherein the method further comprises:
acquiring the three-dimensional joint points of each of the previous two frames of the current frame in the world coordinate system;
calculating pose estimation parameters of each of the previous two frames according to the three-dimensional joint points of each of the previous two frames in the world coordinate system; and
performing interpolation on the pose estimation parameters of each of the previous two frames to obtain the pose estimation parameters corresponding to the current frame.

20. The non-transitory computer-readable storage medium according to claim 17, wherein the multi-lens video is a video obtained by means of a multi-lens camera performing synchronous image collection on hands of the target object.
